(19) United States
(12) Patent Application Publication
(10) Pub. No.: US 2006/0245294 A1
(43) Pub. Date: Nov. 2, 2006

(54) Method for fusing and homogenizing multimodal and bimodal polyolefins

(76) Inventor: Ulrich Burkhardt, Stuttgart (DE)

Correspondence Address: MCGLEW & TUTTLE, PC, P.O. BOX 9227, SCARBOROUGH STATION, SCARBOROUGH, NY, 10510-9227, US

(21) Appl. No.: 10/554,435

(22) PCT Filed: Apr. 8, 2004
(86) PCT No.: PCT/EP04/04156

§ 371 Date: Oct. 24, 2005

(30) Foreign Application Priority Data
Apr. 30, 2003 (EP) 030096481

(51) Int. Cl. B29B 7/48; B29C 47/40; B29C 47/50

(52) U.S. Cl. 366/85; 366/76.4; 366/86; 366/91

(57) ABSTRACT

In a method of melting and homogenizing multimodal and bimodal polyolefins, use is made of a multiple-shaft first extruder (1) and a second extruder (2) which is disposed downstream thereof in the conveying direction (17). The second extruder (2) is also of multiple-shaft design. The outside diameter of the screw shafts (14, 15) of the first extruder (1) is smaller than the outside diameter of the second screw shafts (29, 30) of the second extruder (2). The first extruder (1) is driven at a higher rotational speed than the second extruder (2). The shear rate in the first extruder (1) is higher than in the second extruder (2).

The invention relates to a method according to the preamble of claim 1.

Bimodal or multimodal polyolefin powder has the property of individual particles having molecular-weight distributions which strongly vary from particle to particle and, consequently, strongly varying melt viscosities and elasticity properties. Big particles may originate from small particles agglomerating. Generally, these micro-inhomogeneities pose quite a few problems when processed into a homogeneous polyolefin as a final product.

In the preparation of the mentioned powder compound, the individual particles are melted, however, the high-molecular and thus highly viscous and highly flexible particles stay in the low-viscosity melt matrix and can be deformed or divided only insufficiently in shear fields, in part not at all, resulting in an inhomogeneous matrix in the micro-structure. When granules are being sheared as a final product from such a badly prepared polyolefin of black color that is provided for the manufacture of pipes, these particles appear as an inhomogeneity, even optically in the form of tiny white spots. The problems in this regard will become apparent from the article of Peter Heidemeyer and Joerg Pheiffer in “Macromol. Symp. 181, 167-176 (2002)”.

WO 98/15591 describes a method of the generic type, in which plasticizing takes place in a first two-shaft extruder and homogenizing in a second downstream extruder. The first extruder works at a low shear rate, whereas the second extruder works at a high shear rate. This method is not able to offer a satisfying solution of the problems described at the outset.

DE 43 01 431 C2, U.S. Pat. No. 3,261,056 and German published patent application 23 04 088 (corresponding to U.S. Pat. No. 3,860,220) teach to employ two successively connected single-shaft extruders for melting and homogenizing plastics, the first extruder having a screw shaft of smaller diameter and higher rotational speed and the second extruder a screw shaft of greater diameter and of lower speed. Processing plants of that type have proved not to be suitable in the preparation of the polyolefins mentioned at the outset.

A method of manufacturing aminoplasts and/or phenoplasts is known from EP 1 005 411 B1, in which the precondensate solution is produced in a first extruder and, together with additives and fillers, supplied to a second extruder. In this case, twin-screw extruders are used, having screws that are drivable in the same direction. The first extruder is driven at a very low rotational speed of 12 to 20 min⁻¹ and the second extruder at a higher speed of 20 to 300 min⁻¹, preferaby at a speed of 80 to 150 min⁻¹. Such an extruder cascade is not employable to solve the problems mentioned at the outset in a method of the generic type.

It is an object of the invention to implement polyolefin processing in a method of the generic type for an entirely homogeneous melt matrix to be obtained.

According to the invention, this object is attained by the features of the characterizing part of claim 1. The gist of the invention resides in that melting the multimodal or bimodal polyolefin takes place in the first extruder, which constitutes a first stage, by input of energy that corresponds to slightly more than the melting enthalpy. This melting job takes place at high shear rates, which ensures that the energy input really takes place at any required location. Local differences of energy input that might still exist are compensated by the heat flow from the polyolefin melt that has already formed to polyolefin not yet molten to such an extent that coarsely molten polyolefin is available at the discharge end of the first extruder which constitutes the first stage. Given otherwise constant extruder geometry, the high shear rates are produced by high rotational speed. Homogenizing the polyolefin then takes place at distinctly lower shear rates in the second extruder that constitutes a second stage. The lower shear rates are produced by a correspondingly lower speed. Locally high energy inputs are avoided by the low shear rate. As a result, the melt temperatures are low too and, consequently, the shear forces necessary for deformation and dispersion can act on the micro-structures that constitute the inhomogeneities. Experience has shown that, in these methods, the matrix which embeds the high-molecular particles possesses a higher viscosity due to the lower melt temperature than would be the case with high shear rates. For the sake of completeness attention is drawn to the definition of the shear rate as the rate at which a volume element is sheared i.e., the ratio that the difference in velocity of two layers flowing past one another bears to the distance thereof perpendicular to the direction of flow. In a first rough proximation, the mean shear rate in a screw can be described by the quotient of peripheral speed of the screw and mean channel depth. The use of multiple-shaft and in particular two-shaft extruders helps obtain high stability of conveyance and, consequently, a very uniform course of process. These surprising advantages have become obvious in particular in the use of pulverulent multimodal or bimodal polyolefins, but also of granules thereof and compounds of granules and powder.

The sub-claims reflect advantageous and in part inventive developments of the teaching according to the invention.

Further features, advantages and details of the invention will become apparent from the ensuing description of an exemplary embodiment, taken in conjunction with the drawing, in which

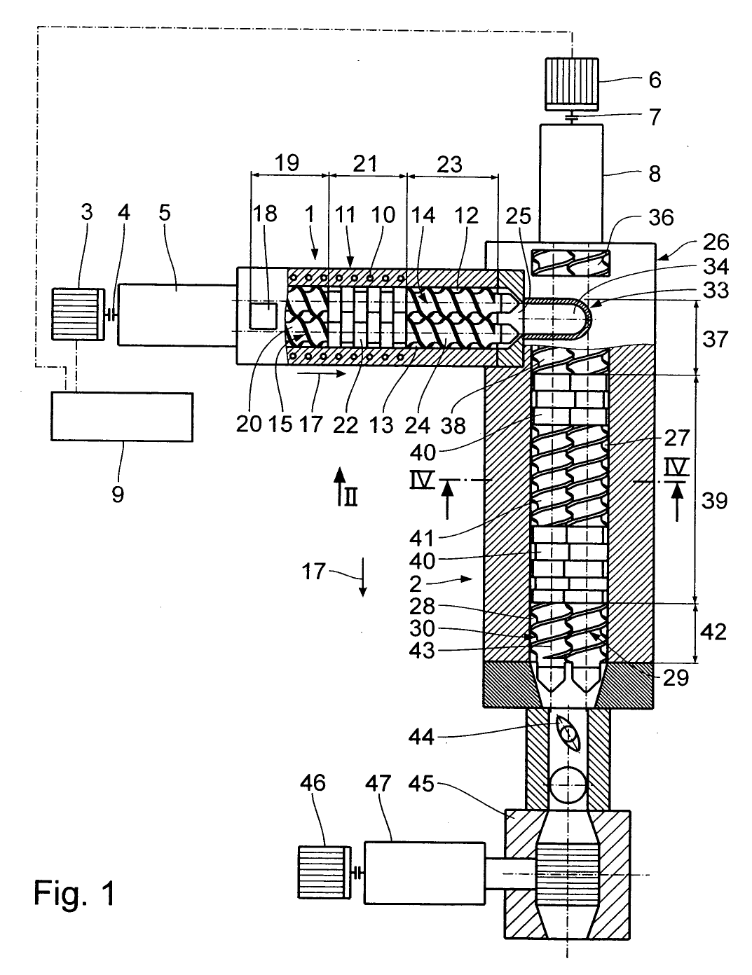

FIG. 1 is a plan view of a processing plant for implementation of the method according to the invention, illustrating extruders that are broken open;

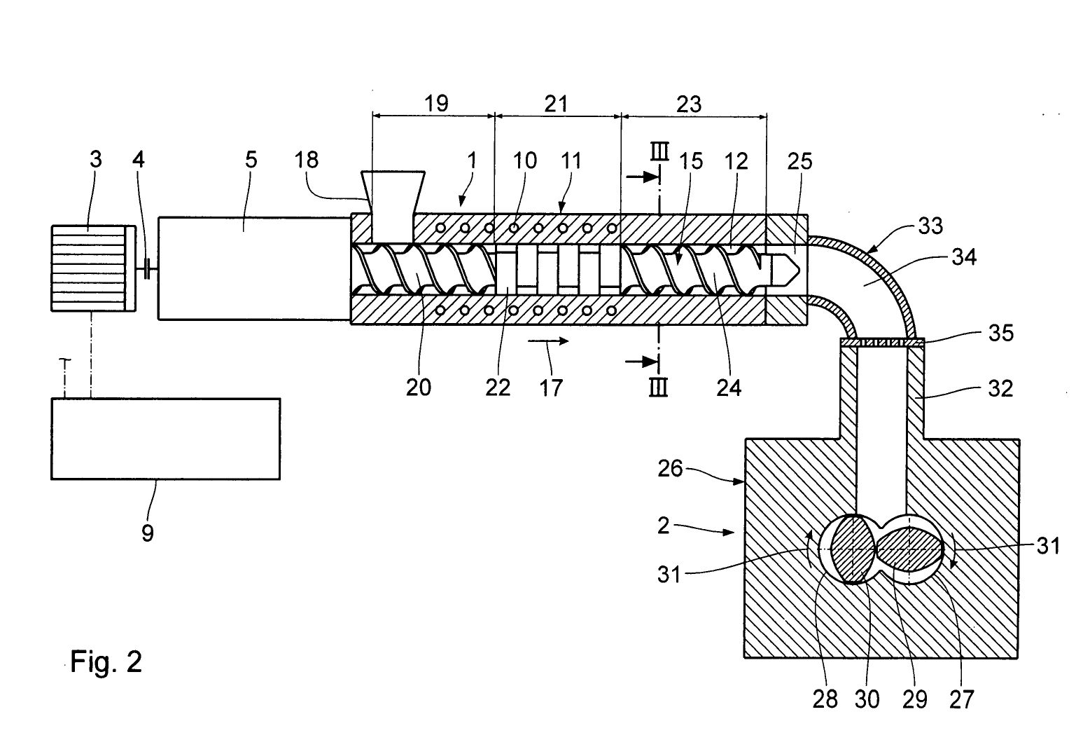

FIG. 2 is a side view of the plant in accordance with the arrow II of FIG. 1, showing extruders that a broken open;

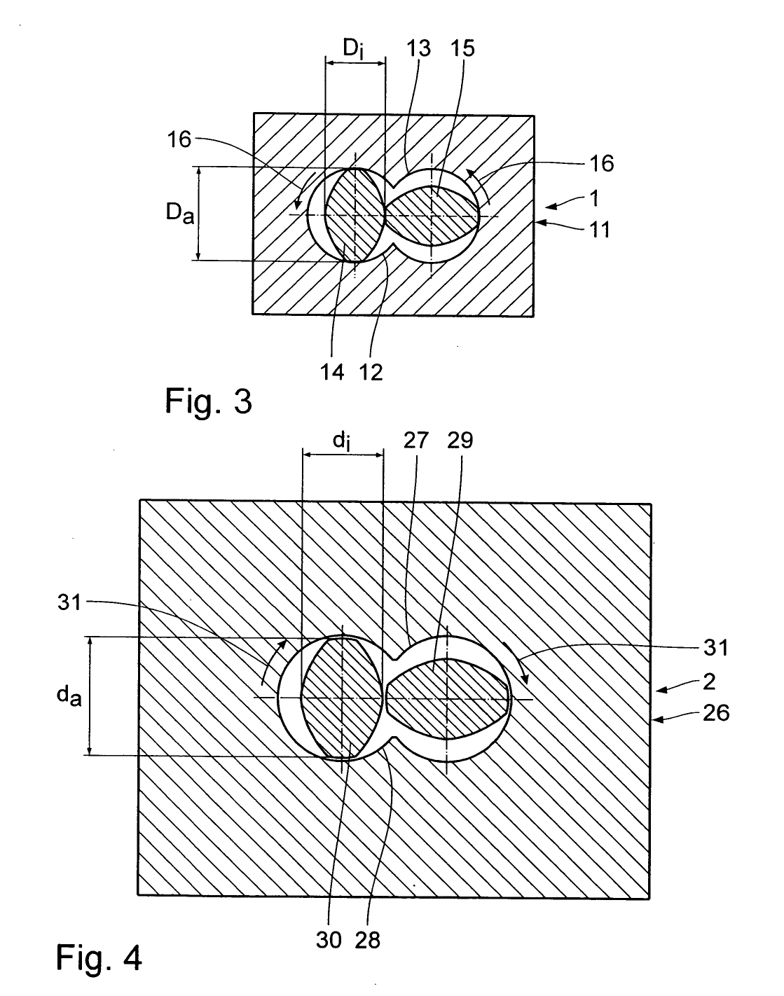

FIG. 3 is a cross-sectional view of the first extruder on the line III-III of FIG. 2; and

FIG. 4 is a vertical sectional view of the second extruder on the line IV-IV of FIG. 1.

The processing plant seen in the drawing comprises a first extruder 1 and a second extruder 2. The first extruder 1 is disposed above the second extruder 2. The first extruder 1 is actuated by a first motor 3 via a first coupling 4 and a first transmission 5. The second extruder 2 is operated by a second motor 6 via a second coupling 7 and a second transmission 8. The motors 3 and 6 are controlled by a control unit 9.

The first extruder 1 comprises a casing 11 which is provided with a heating system 10 and comprises two first casing bores 12, 13 which are parallel and engage with one another in approximately figure-eight-type design. Two first screw shafts 14, 15 are disposed in these casing bores 12, 13; they are coupled to the first transmission 5. The screw shafts 14, 15 are driven in the same direction i.e., in the same direction of rotation 16. They are so-called closely intermeshing screw shafts 14, 15 which are self-cleaning. The first extruder 1 comprises a feed hopper 18 which is disposed downstream of the first transmission 5 as seen in a conveying direction 17 and which is followed by an inlet zone 19 where the screw shafts 14, 15 possess screw elements 20. The inlet zone 19 is followed by a melting zone 21 where the screw shafts 14, 15 are equipped with plasticizing elements, for instance kneading elements 22. This is followed by a feed zone 23 where the shafts 14, 15 are again equipped with screw elements 24. The elements 20, 22, 24 have a first core diameter Dᵢ and a first outside diameter Dₐ. The feed zone is adjoined by a discharge zone 25. Instead of two casing bores and correspondingly two screw shafts, provision may just as well be made for three and more bores and a corresponding number of screw shafts. Sectionally, elements may exist that are not self-cleaning.

The second extruder 2 also has a casing 26 where two second casing bores 27, 28 are formed in parallel to each other and inter-engage, defining a figure-eight-type cross-sectional shape. Two screw shafts 29, 30 are disposed in the second casing bores 27, 28; they are coupled with the second transmission 8 and are rotarily drivable in the same direction i.e., in the same direction of rotation 31. The second screw shafts 29, 30, too, are so-called closely intermeshing and thus self-cleaning screw shafts 29, 30. Adjoining the second transmission 8, the second extruder 2 comprises a feeder connection piece 32 which is connected to the discharge zone 25 of the first extruder 1 by way of a pipe elbow 34 which constitutes a delivery zone 33. In the delivery zone 33, a strainer plate, sieve or the like is disposed as a retaining means 35. A strainer plate has orifices of 1 to 4 mm. A sieve has clearly smaller orifices of, for example, approximately 0.2 mm. It is true also for the second extruder 2 that more than two bores and correspondingly more than two screw shafts may be available, which are not self-cleaning. Furthermore, in the second extruder 2, the drive of the screw shafts may take place in opposite directions, higher pressure build-up being obtained in this way than it is with screw shafts that are driven in the same direction.

Upstream of the feeder connection piece 32—in a direction towards the second transmission 8—provision is made for a vent zone 36 in the form of a so-called reverse venting system. Of course, any other suitable form of venting can be provided at a location where it is considered necessary. In the conveying direction 17, the feeder connection piece 32 is followed by an inlet zone 37 where the second screw shafts 29, 30 are equipped with screw elements 38. This is followed by an elongated homogenization zone 39 where mixing and kneading elements 40 and screw elements 41 are alternately disposed on the screw shafts 29.30. Again a pressure build-up zone 42 adjoins, where the screw shafts 29, 30 are provided with screw elements 43.

Downstream of the pressure build-up zone 42, provision can be made for an adjustable throttle 44, by means of which to modify the input of energy while the speed of the screw shafts 29, 30 remains unchanged. A melt pump 45 is provided, building up especially high pressure; it is a gear-type pump driven by a pump motor 46 with a transmission 47.

The elements 38, 40, 43 have a second core diameter dᵢ and a second outside diameter dₐ.

Multimodal polyolefins, in particular bimodal polyonefins, are prepared in the described processing plant. Melting takes place in the first extruder 1 which plastics are supplied to by the feed hopper 18 in the melting zone 21 by input of mechanical energy and possibly heating energy from outside via the heating system 10. The melting process takes place at a high shear rate and a correspondingly high speed of the first screw shafts 14, 15. The speed is in a range of 200 to 1200 min⁻¹, preferably in a range of 400 to 600 min⁻¹.

The molten plastic material leaves the first extruder 1 in the delivery zone 33 and is fed to the second extruder 2 almost without pressure i.e., at a low pressure. Homogenization of the molten plastics takes place in the second extruder 2; they are then directly discharged or fed by a melt pump 45 for further processing.

The homogenization in the second extruder 2 takes place at a clearly lower shear rate as compared to the first extruder 1 and, consequently, at a lower speed of the second screw shafts 29, 30. These speeds are in a range of 50 to 250 min⁻¹, preferably in a range of 60 to 190 min⁻¹, and by special preference in a range of 80 to 150 min⁻¹. In any case, the speed of the second shafts 29, 30 is lower than that of the first shafts 14, 15. Special efficiency is obtained when the speed of the first screw shafts 14, 15 is constant during operation while the speed of the second screw shafts 29, 30 is adjustable.

As the throughput must of course be the same in both extruders 1, 2, the delivery cross section of the second shafts 29, 30 exceeds that of the first shafts 14, 15. The following applies to the outside-diameter-Dₐ to -dₐ ratio: 0.3≦Dₐ/dₐ≦0.8 and preferably 0.5≦Dₐ/dₐ≦0.8. As for the diameter ratio Dₐ/Dᵢ, the following applies: 1.4≦Dₐ/Dᵢ≦2.1. Correspondingly, 1.4≦dₐ/dᵢ≦2.1 applies to the diameter ratio dₐ/dᵢ of the second screw shafts 29, 30. As a result of the dimensions specified and the mode of operation specified, the melting job takes place very rapidly in the first extruder 1, whereas the homogenization in the second extruder stretches over a longer period. With the extruder 1, 2 that are employed being two- or multiple-shaft machines, steady operation and stable conveyance are ensured as opposed to single-shaft extruders which have a tendency towards pumping.

The multimodal or bimodal polyolefins used are supplied in the form of powder or granules or a mixture of powder and granules. If these polyolefins that are supplied tend to agglomerate or sinter, big agglomerates of powder or granules may form in the melting zone 21, which behave like solids in the melt that surrounds them and are discharged along with the melt by the first extruder 1. They are collected by the retaining means 35 in the form of a coarsely meshed sieve or strainer plate, where they melt until the diameter of these particles has reduced to the orifices of the strainer plate or the sieve. These particles are melted comparatively rapidly by the surrounding hot melt so that it is ensured that all particles are completely molten when entering the homogenization zone 39.

1. A method of melting and homogenizing multimodal or bimodal polyolefins in a first extruder and a second extruder which is disposed downstream thereof in a conveying direction;
wherein the first extruder is a multiple-shaft extruder which has several rotatably drivable first screw shafts;
wherein the second extruder is a multiple-shaft extruder which has several rotatably drivable second screw shafts;
wherein the outside diameter of the first screw shafts is less than the outside diameter of the second screw shafts;
wherein the first screw shafts are driven at a higher rotational speed than the second screw shafts; and
wherein a higher shear rate prevails in the first extruder than in the second extruder.

2. A method according to claim 1, wherein the shear rate in the first extruder is at least twice as high as it is in the second extruder.

3. A method according to claim 1, wherein the shear rate in the first extruder is at least twice as high as it is in the second extruder.

4. A method according to claim 3, wherein the first screw shafts are driven at a rotational speed of 200 to 1200 min⁻¹.

5. A method according to claim 3, wherein the second screw shafts are driven at a rotational speed of 50 to 250 min⁻¹.

6. A method according to claim 1, wherein 0.3≦Dₐ/dₐ≦0.8 applies to the ratio that the outside diameter of the first screw shafts bears to the outside diameter of the second screw shafts.

7. A method according to claim 1, wherein 1.4≦Dₐ/dₐ≦2.1 applies to the ratio that the outside diameter bears to the inside diameter of the first screws shafts.

8. A method according to claim 1, wherein 1.4≦Dₐ/dₐ≦2.1 applies to the ratio that the outside diameter bears to the inside diameter of the second screw shafts.

9. A method according to claim 1, wherein the rotational speed of the first screw shafts is constant.

10. A method according to claim 1, wherein two-shaft extruders are used as at least one of the first extruder and second extruder.

11. A method according to one of claim 1, wherein the polyolefins are supplied to the first extruder in form of powder.

12. A method according to claim 1, wherein at least one of the first screw shafts and second screw shafts are driven for rotation in the same direction.

13. A method according to claim 1, wherein closely intermeshing screw shafts are used as first screw shafts and/or second screw shafts.

14. A method according to claim 1, wherein the molten polyolefin is fed substantially without pressure from the first extruder to the second extruder.

15. A method according to claim 1, wherein the molten polyolefin is strained or sieved prior to entering the second extruder.

16. A method according to claim 1, wherein pressure is built up in at least one of the discharge zone of the second extruder and downstream of the second extruder.

17. A method according to claim 2, wherein the shear rate in the first extruder is four to five times as high as it is in the second extruder.

18. A method according to claim 2, wherein the shear rate in the first extruder is six to ten times as high as it is in the second extruder.

19. A method according to claim 4, wherein the first screw shafts are driven at a rotational speed of 300 to 900 min⁻¹.

20. A method according to claim 4, wherein the first screw shafts are driven at a rotational speed of 400 to 600 min⁻¹.

21. A method according to claim 5, wherein the second screw shafts are driven at a rotational speed of 60 to 190 min⁻¹.

22. A method according to claim 5, wherein the second screw shafts are driven at a rotational speed of 70 to 150 min⁻¹.

23. A method according to claim 6, wherein 0.5≦Dₐ/dₐ≦0.8 applies to the ratio that the outside diameter of the first screw shafts bears to the outside diameter of the second screw shafts.
